(19) United States
(12) Patent Application Publication
(10) Pub. No.: US 2025/0140875 A1
(43) Pub. Date: May 1, 2025

(54) BIFUNCTIONAL SERRATED LEAF-LIKE NITROGEN-DOPED COPPER SULPHIDE OXIDE CATHODE ALLOWING EFFICIENT OXYGEN REDUCTION/EVOLUTION VIA CASCADE AEROBIC AND ANAEROBIC BATTERY MODES FOR HIGH-ENERGY DENSITY AND CYCLE STABILITY IN ZINC-AIR BATTERIES

(71) Applicant: KOREA ADVANCED INSTITUTE OF SCIENCE AND TECHNOLOGY, Daejeon (KR)

(72) Inventors: Jeung Ku KANG, Daejeon (KR); Do Hwan JUNG, Daejeon (KR); Dong Won KIM, Daejeon (KR); Yong Hak PARK, Seoul (KR)

(21) Appl. No.: 18/768,063

(22) Filed: Jul. 10, 2024

(30) Foreign Application Priority Data
Oct. 27, 2023 (KR) 10-2023-0145864
Apr. 2, 2024 (KR) 10-2024-0044768

(51) Int. Cl. H01M 4/90; H01M 4/86; H01M 12/08

(52) U.S. Cl. CPC H01M 4/9016; H01M 4/9075; H01M 12/08; H01M 2004/8689

(57) ABSTRACT

The present disclosure relates to an electrode including a catalyst wherein the catalyst including a nitrogen-doped copper sulfide/oxide, a metal-air battery including the same, and a method of preparing the catalyst including a nitrogen-doped copper sulfide/oxide. The metal-air battery of the present disclosure can operate via aerobic and anaerobic battery modes.

### CROSS-REFERENCE TO RELATED APPLICATIONS

This application claims the benefit under 35 U.S.C. 119(a) of Korean Patent Applications No. 10-2023-0145864 filed on Oct. 27, 2023 and No. 10-2024-0044768 filed on Apr. 2, 2024 in the Korean Intellectual Property Office, the entire disclosures of which are incorporated herein by reference for all purposes.

### TECHNICAL FIELD

The present disclosure relates to an electrode including a catalyst wherein the catalyst including a nitrogen-doped copper sulfide/oxide, a metal-air battery including the same, and a method of preparing the catalyst including a nitrogen-doped copper sulfide/oxide.

### BACKGROUND

Rechargeable electrochemical energy storages are essential in a variety of applications ranging from portable electronics through electric vehicles (EVs) to large-scale grid systems. Nowadays, the most popular electrochemical energy storages are lithium-ion batteries (LIBs) due to their high open circuit voltage and good cycle stability. Meanwhile, the increasing demand for low-weight and miniaturized battery systems continues to drive ultrahigh energy density for prolonged operation upon a single charge and excellent stability over long charge-discharge cycles. Long driving ranges (˜500 km) on a single charge, similar to internal combustion engines, would be difficult to accomplish. As a result, unique chemistry and electrochemical energy storage systems that would allow exceptionally high energy density have been actively sought. Also owing to the high reactivities of lithium metal, LIBs have significant vulnerabilities that could lead to fire and explosions. Toxic and reactive organic solvents add up to the risk factor. Uneven and scarce lithium reserves pose availability issues as well. Metal-air batteries, which consist of an abundant metal anode and an air cathode, have gained considerable attention as a solution to overcome aforementioned challenges.

They may be designed to have a high theoretical energy density that exceeds those of commercial LIBs by even several 10-folds. Metal anodes can be either s-block metals like alkali metals or d-/p-block metals like alkaline earth metals or first-row transition metals. However, because of high reactivity with air and humidity, s-block metals suffer from passivation difficulties and pose safety risks. Substituting s-block metals with d- or p-block metals is being investigated as a possible remedy to these restrictions. Shifting to d- or p-block metals might enable the use of aqueous electrolytes while improving stability and lowering material price. Earth-abundant Zn, in particular, is of importance because of its high capacity leading to high theoretical energy density and low cost. Batteries that employ Zn as an active ingredient have recently been marketed, one of which is a Zn-air battery (ZAB) that uses oxygen (O₂) from air. Oxygen evolution reaction (OER) occurs at the cathode during charge, while oxygen reduction reaction (ORR) occurs during discharge.

Atmospheric oxygen is reduced to hydroxide via ORR, while hydroxide is transformed to release oxygen during OER. ZABs have higher gravimetric and volumetric energy densities than commercial LIBs because oxygen is taken directly from air. However, ZABs still have major drawbacks that hinder their widespread usage. One of these is the slow kinetics for ORR at the cathode, which reduces the energy production of the cell. Also, the irreversibility of ORR during charge and OER during discharge at the cathode causes low capacity retention. Active catalysts that are efficient are required to improve this activity. The ORR volcano plot indicates that Pt is the most suited catalyst, but there are numerous initiatives underway in utilizing non-precious metal catalysts owing to cost and availability difficulties. Copper (Cu) has the highest activity for oxygen reactions amongst non-precious catalysts and in principle it can be further modified to render high activity. Additionally, Cu has a higher standard reduction potential than Zn, signalling that the secondary cathode reaction via the spontaneous reduction of Cu could be designed in the Cu-based cathode electrode for ZABs.

### PRIOR ART LITERATURE

### Patent Literature

Korean Patent Laid-open Publication No. 10-2021-0106331

### SUMMARY

The present disclosure provides an electrode including a catalyst wherein the catalyst including a nitrogen-doped copper sulfide/oxide, a metal-air battery including the same, and a method of preparing the catalyst including a nitrogen-doped copper sulfide/oxide.

However, problems to be solved by the present disclosure are not limited to the above-described problems. Although not described herein, other problems to be solved by the present disclosure can be clearly understood by those skilled in the art from the following descriptions.

A first aspect of the present disclosure provides an electrode, including a catalyst, wherein the catalyst, including a substrate including a copper metal and a copper oxide formed on the copper metal, a copper sulfide formed on the substrate, and a nitrogen dopant existing in each of the substrate and the copper sulfide.

A second aspect of the present disclosure provides a metal-air battery, including: the electrode according to the first aspect; an anode including a metal; and an electrolyte.

A third aspect of the present disclosure provides a method of preparing a catalyst, including: anodizing a substrate including a copper metal and a copper oxide formed on the copper metal using an electrolyte containing sulfur to form a copper sulfide on the substrate, and to obtain a copper sulfide/oxide; and treating with a nitrogen plasma the copper sulfide/oxide to obtain a catalyst.

A catalyst according to embodiments of the present disclosure includes a nitrogen-doped copper sulfide/oxide (CuS/CuO), and has a surface area about 75 times greater than that a bulk copper oxide. Thus, the catalyst according to embodiments of the present disclosure has a sufficient catalytic active site.

A zinc-air battery, which uses an electrode including the catalyst according to embodiments of the present disclosure as a cathode, enables an oxygen reduction reaction (ORR) due to oxygen generated during an oxide reduction process under anaerobic conditions.

The zinc-air battery, which uses an electrode including the catalyst according to embodiments of the present disclosure as a cathode, has a high energy density (667 Wh/kg) and excellent cycle stability under aerobic conditions.

The zinc-air battery, which uses an electrode including the catalyst according to embodiments of the present disclosure as a cathode, has two voltage plateaus through copper oxide transition (CuO→Cu₂O→Cu) under anaerobic conditions and enables an efficient ORR. Therefore, the zinc-air battery of the present disclosure can overcome the limitations of a conventional zinc-air battery containing Pt/C which causes a sudden power loss when air supply is shut off.

### BRIEF DESCRIPTION OF THE DRAWINGS

FIG. 1A to FIG. 1C are schematic diagrams showing a catalyst synthesis process, an ORR, and an OER in a cathode during an operation of a zinc-air battery (ZAB) according to an example of the present disclosure, and specifically show a synthesis procedure for pristine Cu, an anodized copper sulfide/oxide mixture (CuS/CuO), and an N₂ plasma-treated copper sulfide/oxide mixture (N—CuS/CuO) (FIG. 1A); a Zn-air mode operation under aerobic conditions and a Zn—Cu battery mode operation under anaerobic conditions (FIG. 1B); and changes in potential for 1 charge/discharge cycle (left) and X-ray photoelectron spectroscopy (XPS) spectrum matching after transition from CuO into Cu₂O and transition from Cu₂O into Cu (right) (FIG. 1C).

FIG. 2A to FIG. 2H show the results of evaluation of material properties of a catalyst according to an example of the present disclosure, and specifically show field emission scanning electron microscope (FESEM) images of the surface of N—CuS/CuO after anodization (FIG. 2A and FIG. 2B); a high-resolution transmission electron microscope (HRTEM) image of N—CuS/CuO (insert: the result of fast Fourier transform (FFT) analysis) (FIG. 2C); an X-ray diffraction (XRD) spectrum of N—CuS/CuO (FIG. 2D); a deconvoluted Cu 2p XPS spectrum of N—CuS/CuO (FIG. 2E); a Cu-LMM Auger electron spectrum of N—CuS/CuO (FIG. 2F); an N 1s XPS spectrum of N—CuS/CuO (FIG. 2G); and an S 2p XPS spectrum of N—CuS/CuO (FIG. 2H).

FIG. 3A to FIG. 3D show the results of a electrochemical half reaction of a pristine CuS/CuO and N—CuS/CuO air cathode according to an example of the present disclosure, and specifically show a linear sweep voltammogram (LSV) of oxygen reduction activity under Ar and O₂ purging conditions (FIG. 3A); an LSV of oxygen evolution activity of pristine CuS/CuO and N—CuS/CuO (FIG. 3B); cyclic voltammetry (CV) for bifunctional ORR/OER activity of N—CuS (FIG. 3C); and the result of measurement of the linear fitting electrochemical active surface area (ECSA) of pristine Cu metal, anodized CuS/CuO and N—CuS/CuO (FIG. 3D).

FIG. 4A to FIG. 4F show the results of evaluation of characteristics of the ZAB under O₂-rich conditions according to an example of the present disclosure, and specifically show charge/discharge characteristics (LSV) (FIG. 4A); cell potential measurement at various discharge current density conditions (1, 5, 10 and 25 mV) (FIG. 4B); GCPL under 10 mA cm⁻² discharge conditions (FIG. 4C); GCPL under 25 mA cm⁻² discharge conditions (FIG. 4D); GCPL under 10 mA cm⁻² discharge conditions (enlarged) (FIG. 4E); and GCPL under 25 mA cm⁻² discharge conditions (enlarged) (FIG. 4F).

FIG. 5A to FIG. 5F show Zn—Cu mode cell characteristics under O₂-deficient conditions according to an example of the present disclosure, and specifically show schematic diagrams of a conventional Zn-air battery (FIG. 5A) and a cell system in which Zn-air is integrated with Zn—Cu (FIG. 5B); cell potential measurement at various discharge current density conditions (FIG. 5C); enlarged GCPL for a Zn—Cu mode cell (FIG. 5D); and GCPL under discharge conditions of 10 mA and 25 mA (FIG. 5E and FIG. 5F).

FIG. 6A to FIG. 6F show the result of density functional theory (DFT) calculation of ORR performance according to an example of the present disclosure, and specifically show a crystal structure of CuS (FIG. 6A), crystal structures of CuS and doping energies (E_{doping}) after N-substitutional doping (FIG. 6B) and after N-interstitial doping (FIG. 6C); a charge density distribution (FIG. 6D); and absorption energies based on a reaction mechanism (FIG. 6E and FIG. 6F).

FIG. 7A to FIG. 7D show scanning electron microscope (SEM) images of N—CuS/CuO at various levels of magnification according to an example of the present disclosure.

FIG. 8 shows an HRTEM image of N—CuS/CuO (insert: FFT analysis) according to an example of the present disclosure.

FIG. 9 shows XRD patterns of CuS/CuO and N—CuS/CuO after anodization for 10 minutes according to an example of the present disclosure.

FIG. 10A to FIG. 10E show the results of XPS analysis according to an example of the present disclosure, and specifically show a survey spectrum of N—CuS/CuO (FIG. 10A), a deconvoluted Cu 2p spectrum of a CuS sample (FIG. 10B), a deconvoluted Cu 2p spectrum of N—CuS/CuO (FIG. 10C), and Cu LMM spectra of CuS (FIG. 10D) and N—CuS/CuO (FIG. 10E) samples.

FIG. 11A to FIG. 11C show cyclic voltammetry (CV) plots of bare Cu foam (FIG. 11A), CuS/CuO (FIG. 11B), and N—CuS/CuO (FIG. 11C) at various scan rates of 20, 40, 60, 80 and 100 mV/s when a 0.1 M HClO₄ solution is used as an electrolyte according to an example of the present disclosure.

FIG. 12A to FIG. 12C show electrochemical performances of an N—CuS/CuO electrode depending on plasma treatment time (2 minutes, 4 minutes and 6 minutes) according to an example of the present disclosure, and specifically show chronopotentiometry test curves measured at current densities of 1 mA and 5 mA, respectively (FIG. 12A), a constant current charge/discharge cycle at 10 mA (FIG. 12B), and a constant current charge/discharge cycle at 25 mA (FIG. 12C).

FIG. 13A and FIG. 13B show electrochemical performances of the N—CuS/CuO electrode in a stack cell configuration compared to a Pt/C cathode according to an example of the present disclosure, and specifically show the result of linear sweep voltammetry (FIG. 13A) and power density curves of respective cells (FIG. 13B).

FIG. 14 shows the result of measurement of the specific capacity of a cell according to an example of the present disclosure.

FIG. 15A to FIG. 15C show the results of cycle stability tests of conventional batteries using Pt/C (FIG. 15A), Pt/C+RuO₂ (FIG. 15B), and Pt/C+IrO₂ (FIG. 15C) and the ZAB of the present disclosure according to an example of the present disclosure.

### DETAILED DESCRIPTION

Hereinafter, examples of the present disclosure will be described in detail with reference to the accompanying drawings so that the present disclosure may be readily implemented by those skilled in the art. However, it is to be noted that the present disclosure is not limited to the examples but can be embodied in various other ways. In drawings, parts irrelevant to the description are omitted for the simplicity of explanation, and like reference numerals denote like parts through the whole document.

Through the whole document, the term “connected to” or “coupled to” that is used to designate a connection or coupling of one element to another element includes both a case that an element is “directly connected or coupled to” another element and a case that an element is “electronically connected or coupled to” another element via still another element.

Through the whole document, the term “on” that is used to designate a position of one element with respect to another element includes both a case that the one element is adjacent to the other element and a case that any other element exists between these two elements.

Further, through the whole document, the term “comprises or includes” and/or “comprising or including” used in the document means that one or more other components, steps, operation and/or existence or addition of elements are not excluded in addition to the described components, steps, operation and/or elements unless context dictates otherwise.

Through the whole document, the term “about or approximately” or “substantially” is intended to have meanings close to numerical values or ranges specified with an allowable error and intended to prevent accurate or absolute numerical values disclosed for understanding of the present disclosure from being illegally or unfairly used by any unconscionable third party.

Through the whole document, the term “step of” does not mean “step for”.

Through the whole document, the term “combination of” included in Markush type description means mixture or combination of one or more components, steps, operations and/or elements selected from a group consisting of components, steps, operation and/or elements described in Markush type and thereby means that the disclosure includes one or more components, steps, operations and/or elements selected from the Markush group.

Through this whole specification, a phrase in the form “A and/or B” means “A or B, or A and B”.

Hereinafter, embodiments and examples of the present disclosure will be described in detail with reference to the accompanying drawings. However, the present disclosure may not be limited to the following embodiments, examples, and drawings.

A first aspect of the present disclosure provides an electrode, including a catalyst, wherein the catalyst, including a substrate including a copper metal and a copper oxide formed on the copper metal, a copper sulfide formed on the substrate, and a nitrogen dopant existing in each of the substrate and the copper sulfide.

In an embodiment of the present disclosure, the electrode may be a cathode for a metal-air battery, but may not be limited thereto.

In an embodiment of the present disclosure, the substrate may contain pores, but may not be limited thereto.

In an embodiment of the present disclosure, the substrate may include copper foam, but may not be limited thereto.

In an embodiment of the present disclosure, the copper oxide may include CuO and/or CuO₂.

In an embodiment of the present disclosure, the substrate includes a copper metal and a copper oxide formed on the copper metal, and the copper oxide may be formed not by a separate oxidation treatment, but by an oxidation reaction between the copper metal and oxygen in the air.

In an embodiment of the present disclosure, the copper sulfide may include CuS and/or CuS₂.

In an embodiment of the present disclosure, the copper sulfide may include the copper sulfide in the form of a flake.

In an embodiment of the present disclosure, the copper sulfide may include the copper sulfide in the form of a serrated leaf-like.

In an embodiment of the present disclosure, the copper sulfide is provided in the form of the flake on the substrate, which may cause an increase in surface area to mass ratio and an increase in catalytic active site compared to the original substrate.

In an embodiment of the present disclosure, the flake may have a diameter of about 1 μm to about 5 μm and a thickness of about 30 nm to about 70 nm.

In an embodiment of the present disclosure, the flake may have a thickness of about 30 nm to about 70 nm, about 30 nm to about 60 nm, about 30 nm to about 50 nm, about 40 nm to about 70 nm, about 40 nm to about 60 nm, about 40 nm to about 50 nm, about 50 nm to about 70 nm, or about 50 nm to about 60 nm.

In an embodiment of the present disclosure, the catalyst may include a copper metal, a copper oxide formed on the copper metal, and a copper sulfide formed on the copper oxide. Herein, the copper oxide and the copper sulfide may coexist at an interface between the copper oxide and the copper sulfide.

In an embodiment of the present disclosure, the catalyst may exhibit bifunctional catalytic activity for oxygen evolution reaction (OER) and oxygen reduction reaction (ORR).

A second aspect of the present disclosure provides a metal-air battery, including: the electrode according to the first aspect; an anode including a metal; and an electrolyte.

Detailed descriptions on the second aspect of the present disclosure, which overlap with those on the first aspect of the present disclosure, are omitted hereinafter, but the descriptions of the first aspect of the present disclosure may be identically applied to the second aspect of the present disclosure, even though they are omitted hereinafter.

In an embodiment of the present disclosure, the electrolyte may include at least one hydroxide selected from KOH, NaOH, LiOH, Ba(OH)₂, Mg(OH)₂, and Ca(OH)₂, but may not be limited thereto.

In an embodiment of the present disclosure, the metal-air battery may operate under aerobic conditions. In an embodiment of the present disclosure, the metal-air battery may operate under aerobic conditions in the same manner as a typical metal-air battery.

In an embodiment of the present disclosure, when the metal-air battery operates under aerobic conditions, the metal-air battery may have an energy density of about 660 Wh/kg or more.

In an embodiment of the present disclosure, when the metal-air battery operates under anaerobic conditions, the metal-air battery may have an energy density of about 448 Wh/kg or more.

In an embodiment of the present disclosure, the metal-air battery may operate under anaerobic conditions. In an embodiment of the present disclosure, the metal-air battery may operate under anaerobic conditions in the same manner as a typical Galvanic battery without using oxygen in the air because oxygen is generated when the copper oxide transitions into a copper metal.

In an embodiment of the present disclosure, when the metal-air battery operates under anaerobic conditions, the metal-air battery may have two voltage plateaus. The two voltage plateaus may appear through transition from CuO into Cu₂O and transition from Cu₂O into Cu, respectively.

In an embodiment of the present disclosure, the metal-air battery may be a zinc-air battery, an aluminum-air battery, a magnesium-air battery, or a lithium-air battery, but may not be limited thereto.

A third aspect of the present disclosure provides a method of preparing a catalyst, including: anodizing a substrate including a copper metal and a copper oxide formed on the copper metal using an electrolyte containing sulfur to form a copper sulfide on the substrate, and to obtain a copper sulfide/oxide; and treating with a nitrogen plasma the copper sulfide/oxide to obtain a catalyst.

Detailed descriptions on the third aspect of the present disclosure, which overlap with those on the first aspect of the present disclosure, are omitted hereinafter, but the descriptions of the first aspect of the present disclosure may be identically applied to the third aspect of the present disclosure, even though they are omitted hereinafter.

In an embodiment of the present disclosure, the substrate may contain pores, but may not be limited thereto.

In an embodiment of the present disclosure, the substrate may include copper foam, but may not be limited thereto.

In an embodiment of the present disclosure, the electrolyte containing sulfur may include at least one selected from Na₂S and K₂S, but may not be limited thereto.

In an embodiment of the present disclosure, the electrolyte containing sulfur may have a concentration of about 1 M to about 2 M, but may not be limited thereto.

In an embodiment of the present disclosure, the anodizing may be performed for about 1 minute to about 30 minutes, but may not be limited thereto.

In an embodiment of the present disclosure, the anodizing may be performed for about 1 minute to about 30 minutes, about 1 minute to about 25 minutes, about 1 minute to about 20 minutes, about 1 minute to about 15 minutes, about 1 minute to about 10 minutes, about 5 minutes to about 30 minutes, about 5 minutes to about 25 minutes, about 5 minutes to about 20 minutes, about 5 minutes to about 15 minutes, or about 5 minutes to about 10 minutes, but may not be limited thereto.

In an embodiment of the present disclosure, the copper sulfide/oxide may include a substrate including a copper metal and a copper oxide formed on the copper metal; and a copper sulfide formed on the substrate.

In an embodiment of the present disclosure, the copper oxide may be formed not by a separate oxidation treatment, but by an oxidation reaction between the copper metal and oxygen in the air.

In an embodiment of the present disclosure, the copper oxide may include CuO and/or CuO₂.

In an embodiment of the present disclosure, the copper sulfide may include CuS and/or CuS₂.

In an embodiment of the present disclosure, the copper sulfide may include the copper sulfide in the form of a flake.

In an embodiment of the present disclosure, the copper sulfide may include the copper sulfide in the form of a serrated leaf-like.

In an embodiment of the present disclosure, the copper sulfide/oxide may have a surface area about 41 times or more or about 42 times or more greater than the original substrate.

In an embodiment of the present disclosure, the treating with a nitrogen plasma may be performed for about 1 minute to about 10 minutes, but may not be limited thereto.

In an embodiment of the present disclosure, the treating with a nitrogen plasma may be performed for about 1 minute to about 10 minutes, about 1 minute to about 8 minutes, about 1 minute to about 6 minutes, about 1 minute to about 5 minutes, about 1 minute to about 4 minutes, about 2 minutes to about 10 minutes, about 2 minutes to about 8 minutes, about 2 minutes to about 6 minutes, about 2 minutes to about 5 minutes, about 2 minutes to about 4 minutes, about 3 minutes to about 10 minutes, about 3 minutes to about 8 minutes, about 3 minutes to about 6 minutes, about 3 minutes to about 5 minutes, about 3 minutes to about 4 minutes, about 4 minutes to about 10 minutes, about 4 minutes to about 8 minutes, about 4 minutes to about 6 minutes, or about 4 minutes to about 5 minutes, but may not be limited thereto.

In an embodiment of the present disclosure, the nitrogen plasma treatment may be performed by plasma enhanced chemical vapor deposition, but may not be limited thereto.

In an embodiment of the present disclosure, the copper sulfide may be changed from the form of the flake to the form of the serrated leaves through the nitrogen plasma treatment.

In an embodiment of the present disclosure, the catalyst may be the copper sulfide/oxide doped with nitrogen (i.e., the copper sulfide/oxide containing a nitrogen dopant).

In an embodiment of the present disclosure, the catalyst may have a surface area about 1.8 times or more greater than the copper sulfide/oxide.

In an embodiment of the present disclosure, the catalyst may have a surface area about 75 times or more greater than the original substrate.

Hereinafter, example embodiments are described in more detail by using Examples, but the present disclosure may not limited to the Examples.

### EXAMPLE

### 1. Experiment

### Synthesis of Copper Sulfide (CuS)

Copper sulphide nanoflakes were prepared by the electrochemical anodization method. Cu foams were washed with acetone and distilled water. The cleaned Cu foams were used as an anode and the carbon paper was a cathode with 1.5 M Na₂S electrolyte solution. Then a galvanostatic system at oxidation current 10 mA was performed for different times of 5 min, 10 min, and 15 min at 0° C. The obtained samples were washed with distilled water several times and dried at room temperature.

### Preparation of Nitrogen Doped Copper Sulfide/Oxide (N—CuS/CuO)

N₂ plasma treatment was carried out with plasma-enhanced chemical vapor deposition (PECVD, Woosin CryoVac, Korea). To prevent the nanoflakes from being destructed due to direct exposure, a Si shield is added on top of the copper sulphide/oxide nanoflakes. In order to find out the nitrogen doping effect and battery performance according to the plasma time, execution time is differently given as 2 min, 4 min, and 6 min.

### Preparation of Pt/C Control Catalyst Ink

The amount of active material grown on the copper foam substrate have been assessed using ICP-OES (ICP-OES 5110, Agilent) and XPS analysis in conjunction. From the total mass percentage obtained from ICP-OES results and oxidation state ratio calculated from deconvoluted XPS spectra, the total active material on unit area of copper foam substrate has been determined as 1.229 mg/cm². A catalyst ink was prepared by suspending 10 mg of Pt/C (20% wt Pt, Sigma-Aldrich) in a mixture of 900 μL isopropyl alcohol and 100 μL Nafion solution (5% Nafion 1100W solution, Sigma-Aldrich) by sonication for at least 15 minutes.

### Preparation of Pt/C Control Electrode

The catalyst ink prepared as described above was drop-cast onto carbon paper and copper foam substrates. Each samples were coated with 123 μl of abovementioned ink. The ink was dropped at maximum volume of 25 μl per each drop, and subsequent drops were added after the previous one was fully dry.

### Flow Cell Configuration

A flow cell separated with a membrane was adopted for Zn-air cell electrochemical measurements. First of all, Zn metal was prepared as anode. The N—CuS and carbon paper with mesoporous layer was used for cathode electrode. Anode and cathode electrodes were attached with copper tape. 6 M KOH electrolyte and anion exchange membrane were applied to electrolyte and separator, respectively.

### Stack Cell Configuration

A stack cell configuration was adopted for Zn-air cell electrochemical measurements. Thin Zn sheet (0.05 mm) was polished and washed before being used as the anode. N—CuS/CuO, as the air cathode, cut to fit the gas inlet of the stack cell was covered with MPL to prevent leakage. Anode was directly connected to the potentiostat using alligator clips, while for the cathode a strip of copper tape was used as the current collector that connects the wire to the cathode. 6 M KOH and anion exchange membrane were selected as the electrolyte and separator, respectively.

### Characterization

The images of pristine CuS/CuO and N-doped N—CuS/CuO for morphological study were captured using Field Emission Scanning Electron Microscope (FESEM, Hitachi, SU8230 and FEI Company, Magellan 400). The crystal structure analysis was conducted by X-ray diffraction (XRD, Rigaku SmartLab) using Cu Kα radiation operating condition of 40 kV and 30 mA (FIG. 9). To study surface chemical states, X-ray photoelectron spectroscopy (XPS) analysis and Auger electron spectroscopy (AES) were performed by Kratos Axis-Supra with Al(1486.7eV) as the X-ray source.

### Electrochemical Measurement

The three electrode H type electrochemical cell was constructed to measure half-cell ORR/OER performance. Pt coil counter electrode, Hg/HgO (RE-61AP, in 1 M KOH solution) reference electrode and 1 M KOH electrolyte was used respectively. The linear sweep voltammetry (LSV) was conducted from open circuit potential to 0.3 V vs. RHE for ORR and from open circuit potential to 1.75V vs. RHE for OER under Ar purging and O₂ purging conditions, respectively. Cyclic voltammetry (CV) from 0.3 V to 1.2 V vs. RHE is measured to demonstrate the reversible catalytic activity. The electrochemically active surface area was studied by multiple CV measurements with various scan rates of 20, 40, 60, 80 and 100 mV/s.

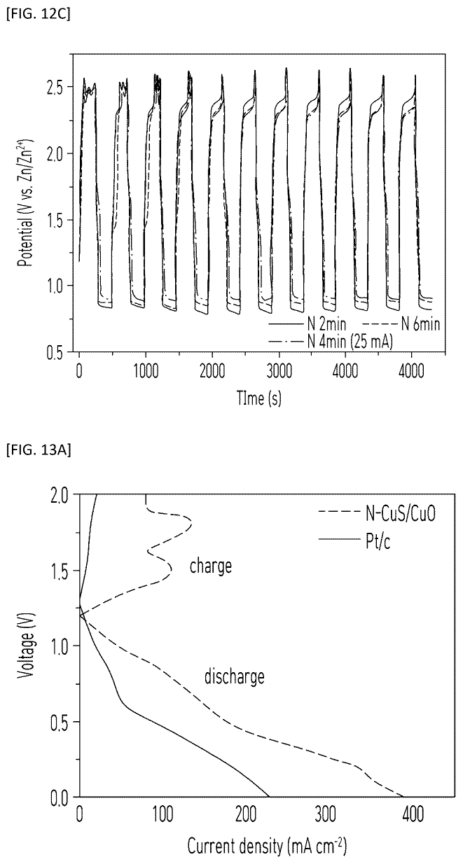

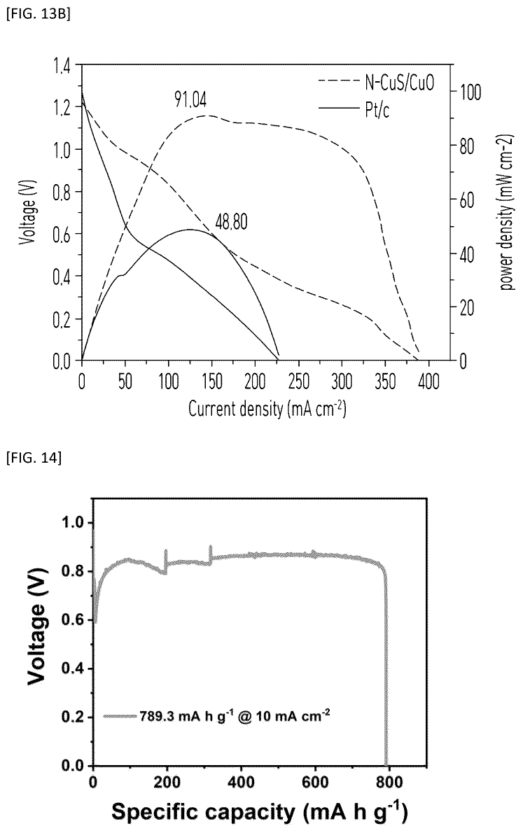

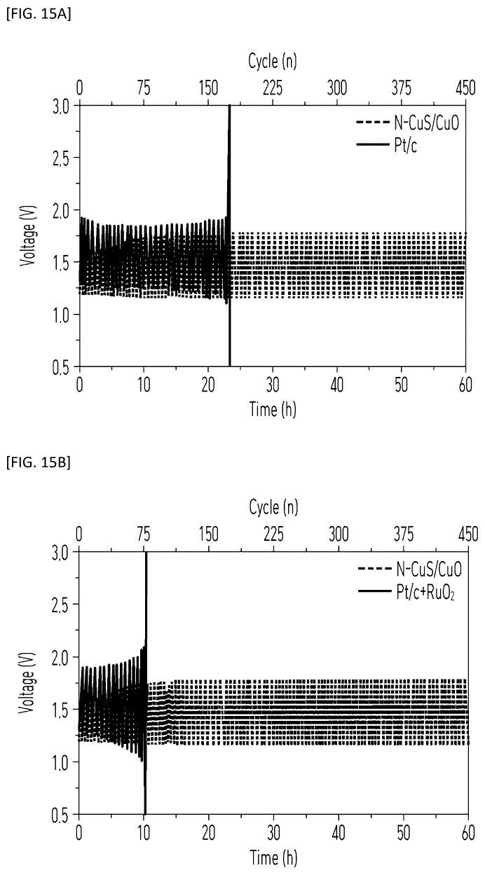

Zn-air battery performance was tested by Chronopotentiometry (CP) test in various discharge current density conditions, 1, 5, 10, 25 mA and galvanostatic cycling with potential limitation (GCPL) at a current density of 10 mA cm⁻², 25 mA cm⁻² with the different gas condition, O₂ and Ar purging, respectively (FIG. 12B and FIG. 12C).

### DFT Analysis of Electrocatalysts

The DFT calculations with a plane-wave basis set were performed by Vienna ab initio simulation package (VASP). Perdew-Burke-Ernzerhof (PBE) functionals, which are based on a generalized gradient approximation (GGA) scheme, were adoped as exchange and correlation energies for DFT. Also, the spin polarization and van der Waals (vdW) interaction with the DFT-D3 method were also included for improved accuracy. The energy and force convergences were 10⁻⁵ eV and 0.01 eV/Å, and the energy cutoff of the plane wave basis set was 520 eV in all calculations. The Brillouin zone was sampled by 6×3×1 k-point grid for a bulk optimization, 3×4×1 k-point grid for surface slab model and a vacuum space of more than 15 Å was guaranteed along the z-direction to neglect the interaction between the subsequent slabs. To cancel out the pseudo electric field effect due to dipole moment at slab model, dipole correction was applied by making a potential jump between surfaces.

### 2. Results

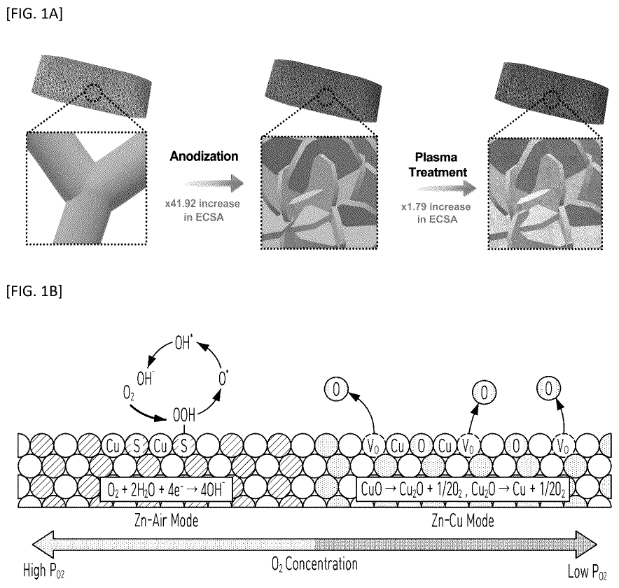

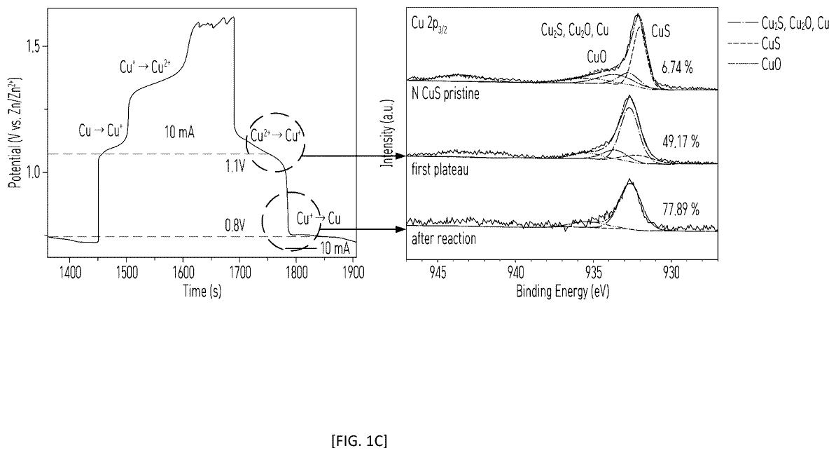

The synthesis procedure is depicted in FIG. 1A. Anodization is a procedure for generating a defect-rich surface. The chemical reactions driven by electric energy modifies the electrode surface, and a variety of methods for element deposition are available depending on the electrolyte, we used a sodium sulphide (Na₂S) electrolyte to form copper sulphide structures on the electrode surface after electrolysis. After anodization, the resulting copper sulphide oxide mixture (CuS/CuO) structure was found to result in a about 41.9-fold increased surface area (FIG. 1, middle). Subsequently, the subsequent procedure to incorporate reactive nitrogen (N₂) plasma species into copper sulphides was found to enable a 1.8-fold increased surface area (FIG. 1, right). The resulting nitrogen-doped copper sulphide oxide (N—CuS/CuO) structure possesses about 75-fold increase in the catalytically active surface area. Nitrogen dopants were demonstrated to enhance the affinity of catalytic sites for oxygen as well as conductivity. Also, the produced cathode material exhibits two modes of cathode reactions. Under the aerobic condition, the N-doped cathode material runs in a normal air-cell mode when exposed to oxygen in which oxygen from the ambient air is transformed to hydroxides, as depicted in FIG. 1B. However, under anaerobic circumstances, copper oxides left after anodization are consumed in the cathodic reaction in which copper oxides are converted to metallic coper, thereby allowing the ZAB to operate without the use of oxygen from air. The left side of FIG. 1C also shows a plot of charging and discharging over time. Indeed, two plateaus were found at 1.1 V and 0.8 V, which correspond to the voltages at which Cu²⁺ for CuO is reduced to Cu⁺ for Cu₂O and ultimately to Cu (pristine Cu). As a result, during discharge, this cascade battery-mode operation including copper oxide transitions (CuO→Cu₂O→Cu) led in the formation of O₂ molecules, permitting efficient ORR under anaerobic circumstances. As a consequence, when used as a flow cell, N—CuS/CuO electrode was shown to be stable even in oxygen-deficient conditions. Furthermore, after each stage of Cu reduction, the electrodes were removed from the cell and analyzed using XPS. The XPS spectra (right side of FIG. 1C) show that the copper is reduced at each stage, indicating that cascade redox oxide transitions occur in an oxygen-free environment. Referring to the XPS spectra (right side of FIG. 1C), it can be seen that after the cell reaction proceeds under anaerobic conditions, the compositions of Cu₂S, Cu₂O, and Cu which are reduced forms further increase, reaching 49.17% (corresponding to the CuO→Cu₂O reaction) and 77.89% (corresponding to the Cu₂O→Cu reaction).

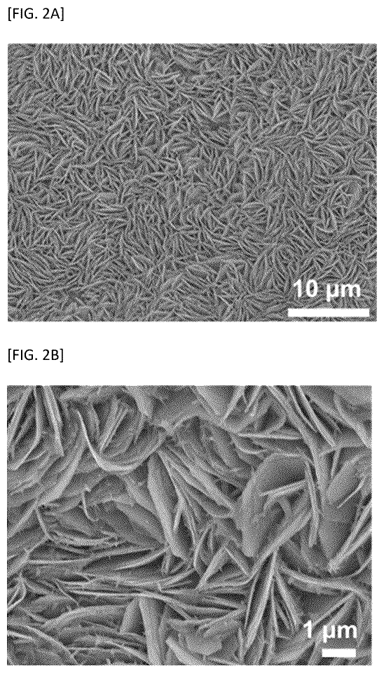

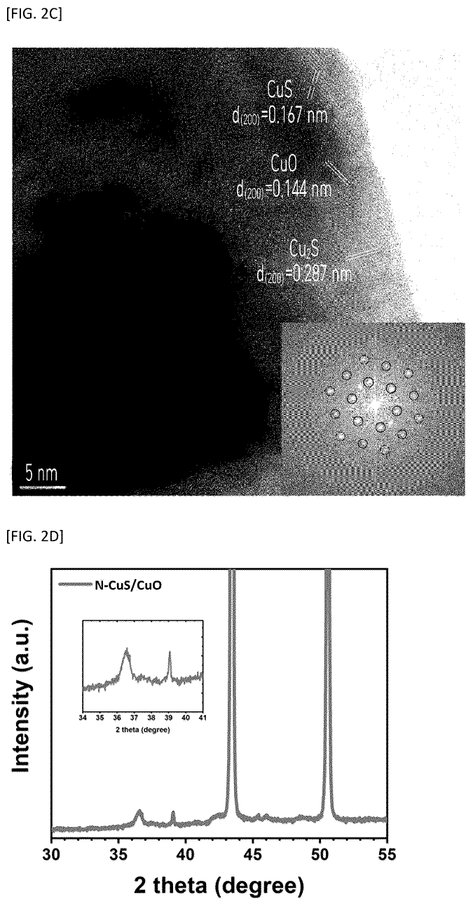

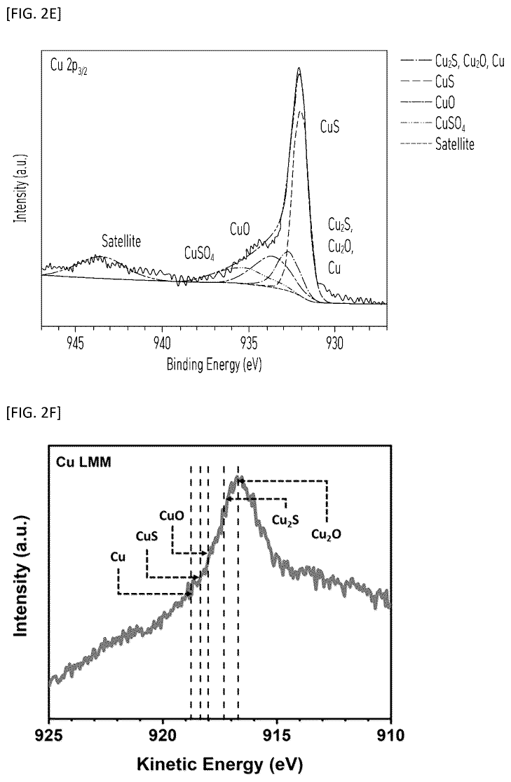

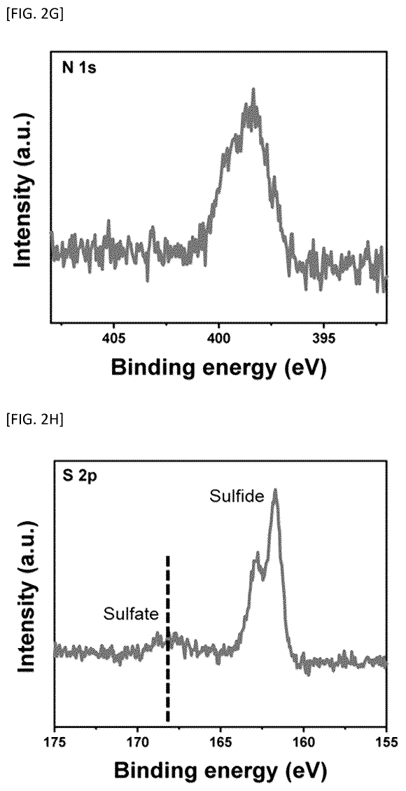

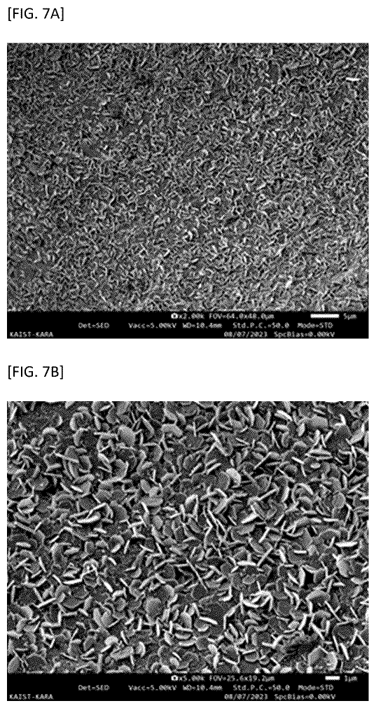

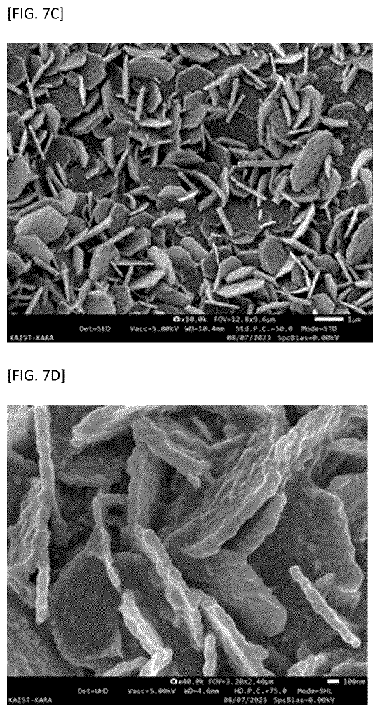

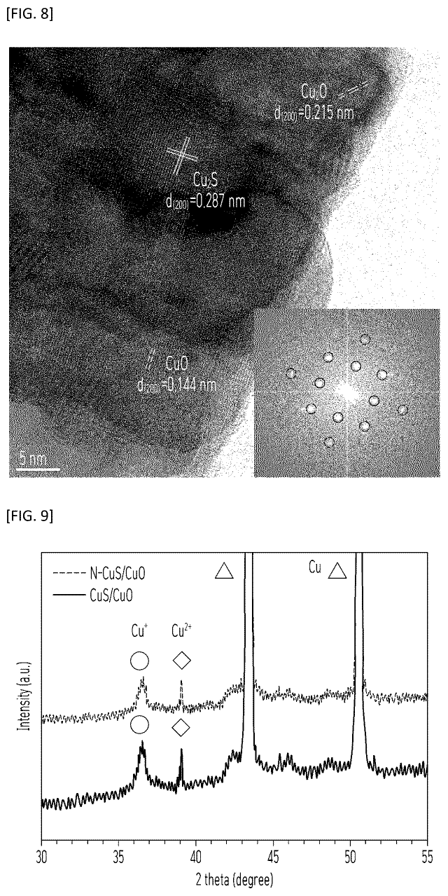

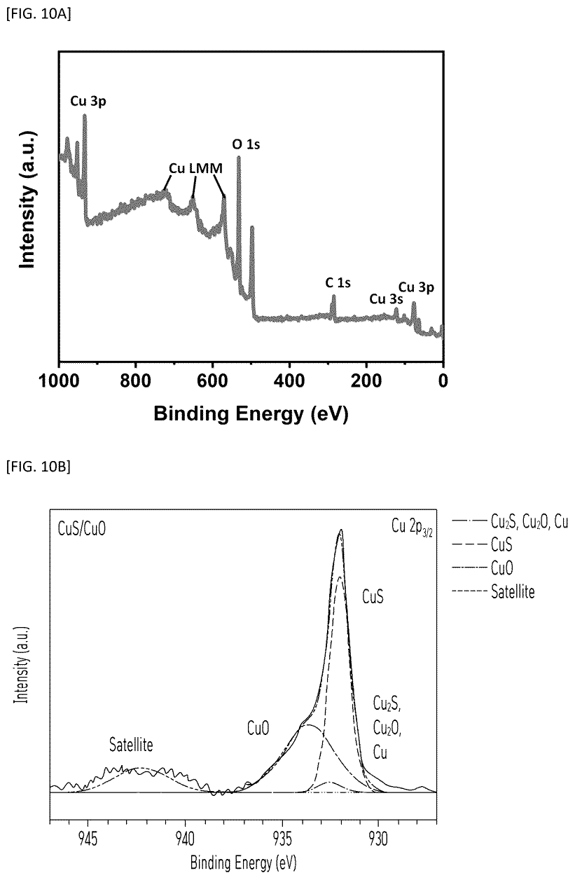

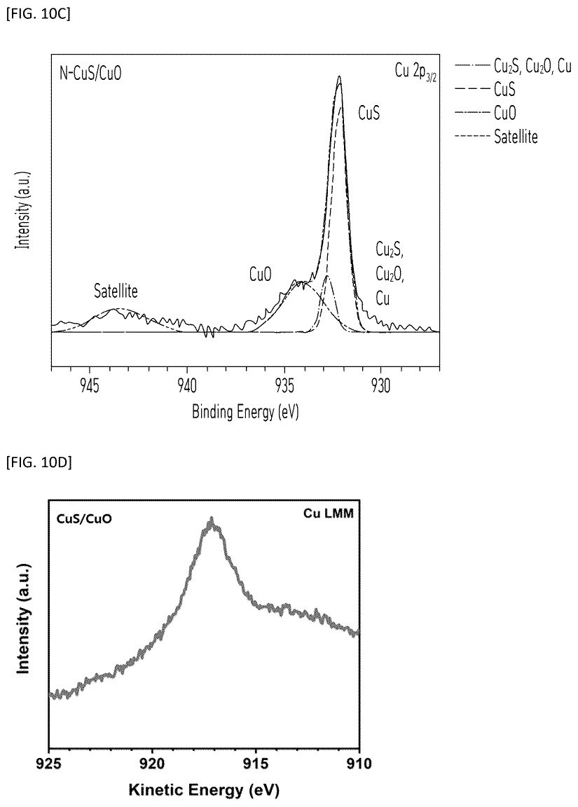

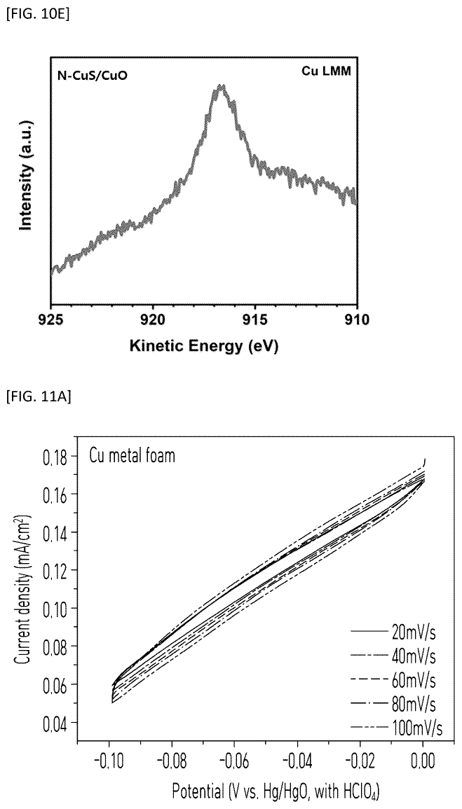

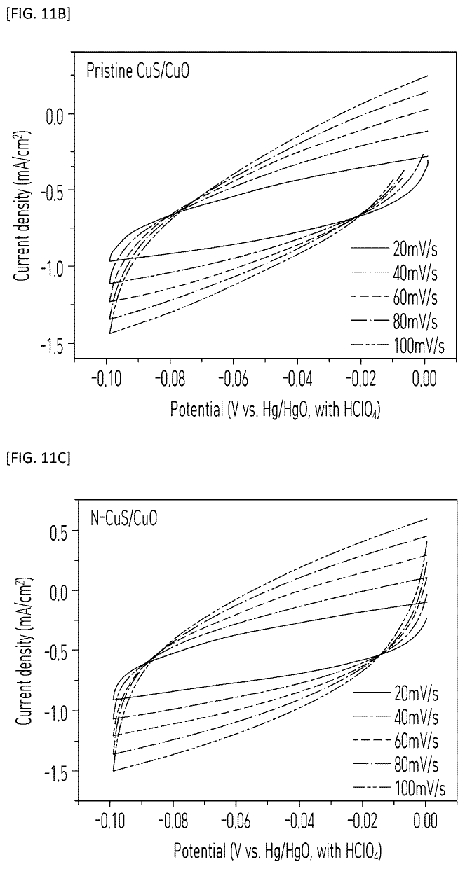

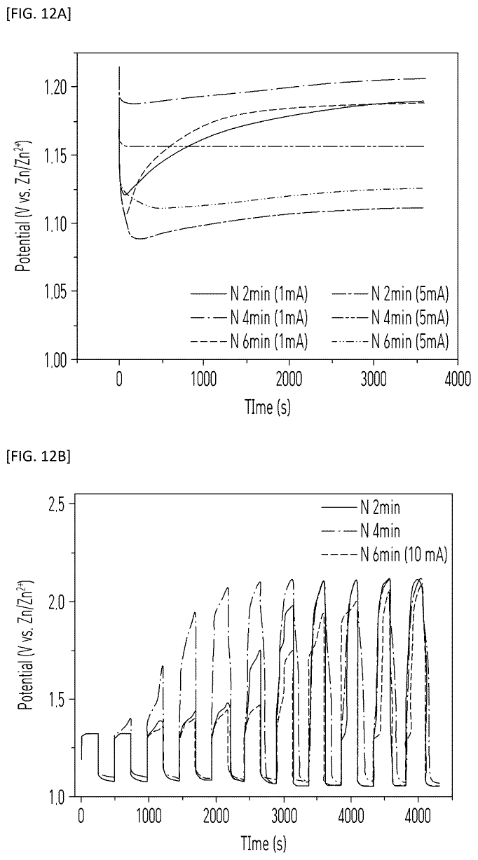

Moreover, the field-emission scanning microscopy (FESEM) images have been acquired after each procedure to elucidate the influence of anodizing and plasma processes on surface morphology. FIG. 7A to FIG. 7D reveal that the material after anodization has a densely packed flake-like structure. This structure allows facile accessibility to active sites by increasing the surface area-to-mass ratio. After examining the effects of anodization over time, the best anodization conditions for maximal catalytic activity was also determined. The material was then further modified by reactive nitrogen plasma and this process was proven to turn the flakes into serrated leaf-like shapes (FIG. 2A and FIG. 2B). Each leaflet is a few micrometers long on the side and a thickness of 50 nm. The appropriate time for the procedure was determined by analyzing SEM images after varying the lengths of plasma treatment to assure improved catalytic activity while avoiding damage to the morphology caused by the extended exposure to high-energy plasma. Moreover, high-resolution transmission electron microscopy (HRTEM) has been employed to define the information on the shape, size, and plane of N—CuS/CuO in detail. The HRTEM images of N—CuS/CuO (FIG. 2C and FIG. 8) reveal that (200) lattice plane of CuS (d=0.167 nm), (200) lattice plane of Cu₂S (d=0.287 nm), (022) lattice plane of CuO (d=0.144 nm), and (200) lattice plane of Cu²O (d=0.215 nm). In addition, the XRD patterns were obtained using Cu K-α source (0.15406 nm) to determine the crystalline structures of pristine CuS/CuO and N-doped CuS/CuO (N—CuS/CuO). As illustrated in FIG. 2D, the XRD spectra show prominent peaks corresponding to the plane of copper metal (PDF #00-001-1241), such as Cu (111) peak at 2θ=43.47° and Cu (200) peak at 2θ=50.37°. The peak at 2θ=36.54° comes from (111) plane of Cu₂O (PDF #00-001-1142) while the peak at 2θ=39.04° comes from (111) plane of CuO (PDF #00-001-1117). The XRD spectra show the discrete peaks relating to copper metal, as well as the peaks attributed to the varying degrees of copper oxidation in copper oxide. The lack of copper sulphide peaks for crystalline CuS and Cu²S phases in the anodized CuS/CuO structure shows that sulphur treatment took place solely on the surface. Additionally, it appears that nitrogen dopants have minimal influence on the crystalline structure, as evidenced by the absence of variations in the peaks between pristine CuS/CuO and N—CuS/CuO. In addition, to elucidate the surface chemical state, X-ray photoelectron spectroscopy (XPS) and Auger electron spectroscopy (AES) analyses have been performed (Kratos Axis-Supra with Al(1486.7 eV) as the X-ray source), and the spectra (FIG. 2F to FIG. 2H) were analyzed. The survey (FIG. 10A) reveals Cu 3p peaks, Cu LMM peaks, O 1s peak, and C 1s peak. The adventitious carbon peak around 248.8 eV was chosen as the reference. Furthermore, Auger electron spectra (FIG. 2F) were obtained since the oxidation state of copper cannot be determined from Cu 2p spectra (FIG. 2E). According to the deconvolution of the obtained and known Cu spectra (CuS at 932.2 eV, Cu₂S at 932.5 eV, Cu₂O at 932.5 eV, and CuO at 933.6 eV), the specimens were observed to consist of copper sulphides and oxides (CuS, Cu₂S, Cu₂O, and CuO).

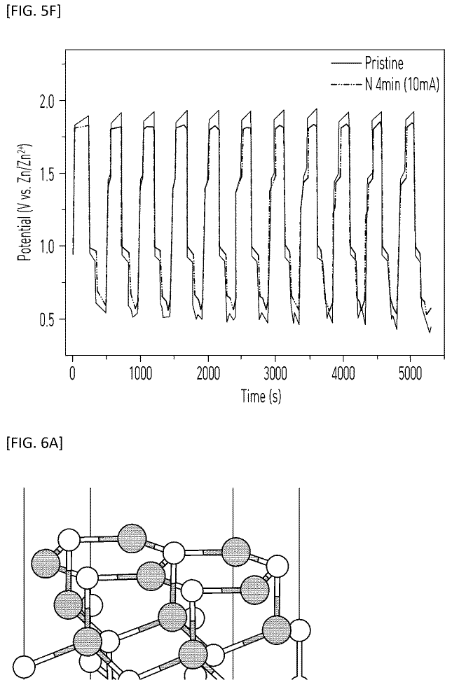

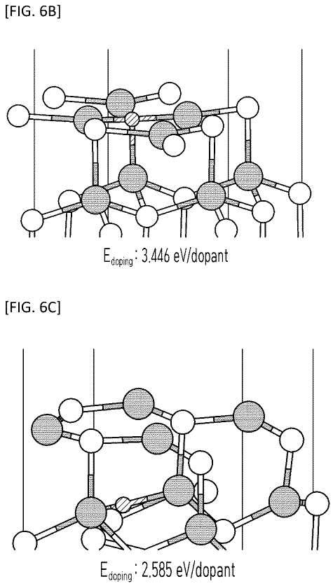

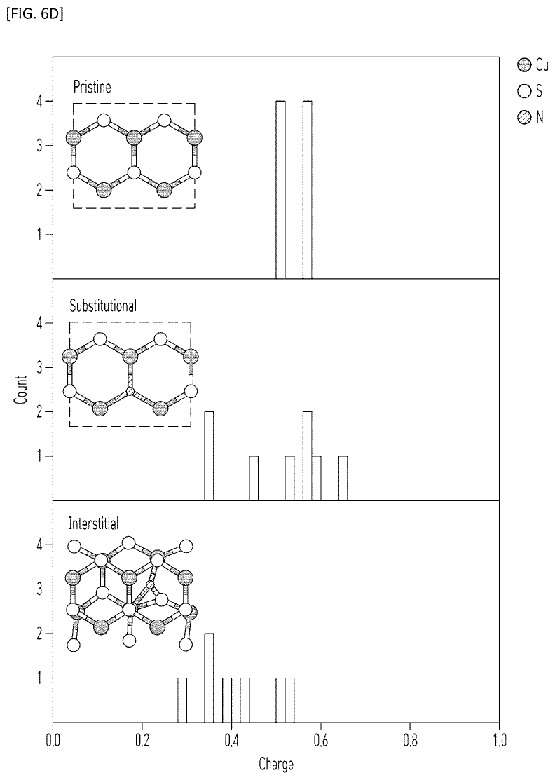

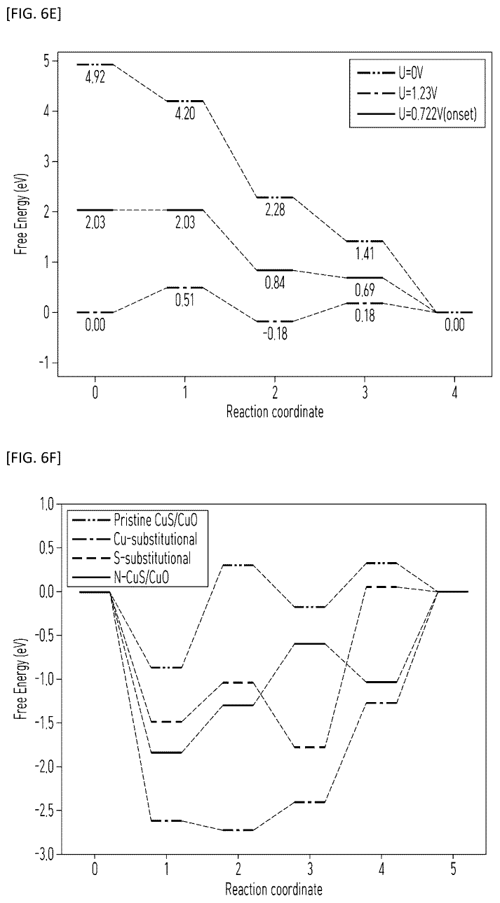

We also explored the formation energies and stable structures of copper sulphides depending on S fractions by density functional theory (DFT) calculations. It can be seen that a mixture of CuS and CuS₂ phases could be formed in the S-fraction range of 0.5 to 0.65. Also, it can be seen that the two different Cu—S—S—Cu—Cu—S or Cu—S—Cu—S—Cu—S configurations produce distinct surfaces, which are attributed to the different types of bonds that need to be broken in order to generate the surface. Moreover, the existence of nitrogen atoms has been confirmed by the signal at 397 eV inside N 1s region. The structures and their stability of N—CuS phase have been also explored through the DFT calculations with different ranges of doping N concentrations. The results demonstrate that interstitially N-doped structures were found to be more stable than substitutional. (Describe more details of the formation energy and geometries for FIG. 6A to FIG. 6C) Moreover, Bader charge analysis was carried out to determine the net charge distribution of Cu atoms in the top two layers. FIG. 6D demonstrates that Cu atoms in interstitial doping are more reduced than those in the pristine structure, while Cu atoms in substitutional doping are partially oxidized. These theoretical results agree with the XPS spectra on FIG. 2H and FIG. 10A to FIG. 10E, which demonstrate an increased Cu⁺ to Cu²⁺ ratio following N doping. FIG. 2H reveals the asymmetric and unresolved S 2p_{1/2} and S 2p_{3/2} peaks at 163 eV and 161 eV, respectively, attributable to the metal sulphide spin-orbit doublet. Additionally. the double peaks at 169 eV and 166 eV represent the characteristics of metal sulphates.

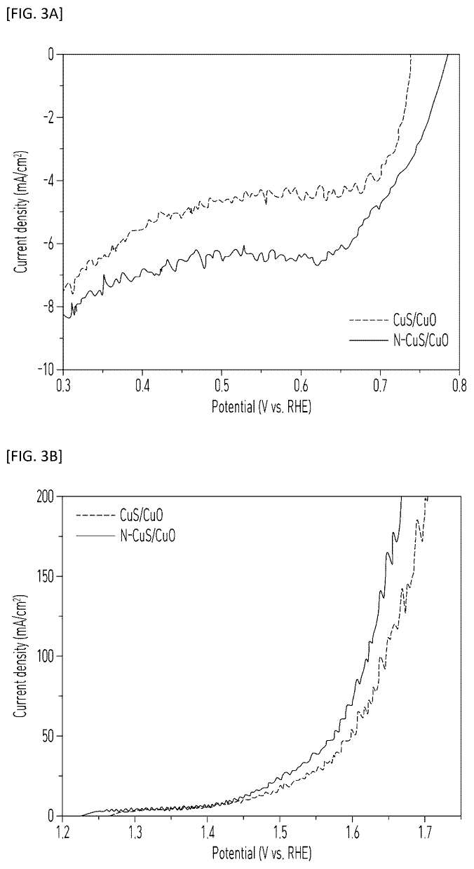

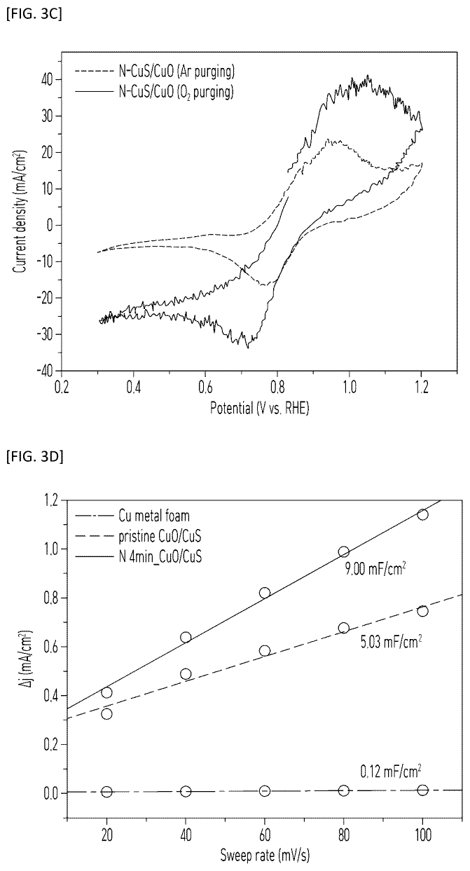

The half reaction kinetics of N—CuS/CuO cathode have been studied in three-electrode electrochemical cell system before confirming the ZAB properties. A coiled Pt electrode, Hg/HgO electrode (RE-61AP, in 1 M KOH solution), and 1 M KOH were used as a counter electrode, reference electrode, and electrolyte, respectively. Also, the linear sweep voltammetry (LSV) analysis was carried out to determine the electrochemical ORR/OER characteristics (FIG. 3A FIG. 3B). The ORR activities of pristine CuS/CuO and N—CuS/CuO were elucidated by comparing the current densities under different gas purging conditions (Ar purging and O₂ purging) in a potential window from the open circuit potential to 0.3 V vs. RHE. Although pristine copper sulphides exhibit oxygen reduction activity under O₂ purging condition, N—CuS/CuO demonstrated a current density of 7 mA/cm², which is more than 2-fold greater than pristine catalyst when the cathodic potential is less than 0.65 V vs. RHE (FIG. 3A). Furthermore, after nitrogen doping, the onset potential was observed to shift about 35 mV to the anodic direction. The increased ORR activity is significant because the energetic capacity of the ZAB is dictated by the reaction kinetic of Zn-metal oxidation and oxygen reduction. Bifunctional ORR/OER capability should be secured for reversible operation of ZABs. The OER activity was also measured by the LSV analysis under a potential window ranging from the open circuit potential to 1.75 V vs. RHE. Both CuS and N—CuS exhibited OER activities. FIG. 3B shows that the overpotential shifts to 471 mV after nitrogen doping. To elucidate the reversible catalytic activity of N—CuS/CuO, cyclic voltammetry (CV) analysis from 0.3 V to 1.2 V vs. RHE was performed. The bifunctional ORR/OER catalytic activity of N—CuS was confirmed by comparing the purging conditions to Ar and O₂ (FIG. 3C). In addition, the electrochemically active surface area (ECSA) was calculated using multiple CV measurements with various scan rates of 20 mV/s, 40 mV/s, 60 mV/s, 80 mV/s and 100 mV/s to determine double layer capacitance (C_{dl}). Subtracting cathodic current density from anodic current density (iₐ-i_{c}) yields the double layer capacitance. The calculated C_{dl} of anodized CuS is 5.03 mF/cm², which is higher than pristine Cu metal (0.12 mF/cm2), as revealed in FIG. 3C and FIG. 3D. Furthermore, after nitrogen plasma treatment, Cdi increased to 9.00 mF/cm², indicating that N—CuS has a substantially increased surface area for catalytic activity.

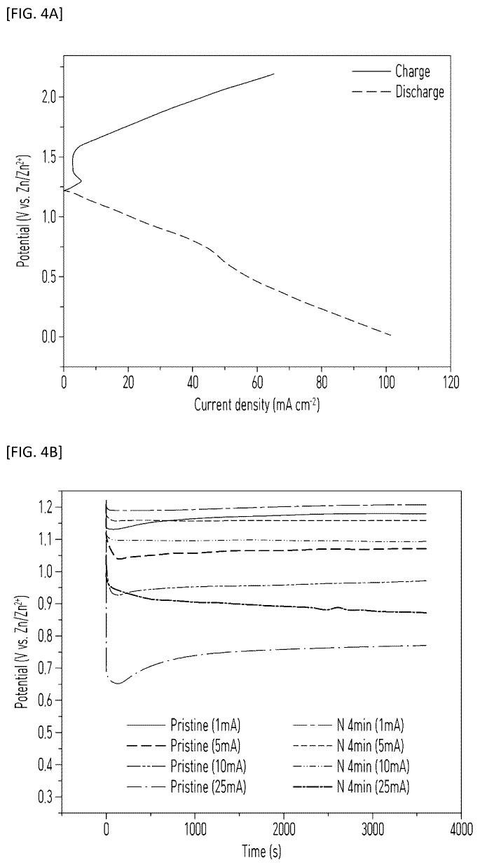

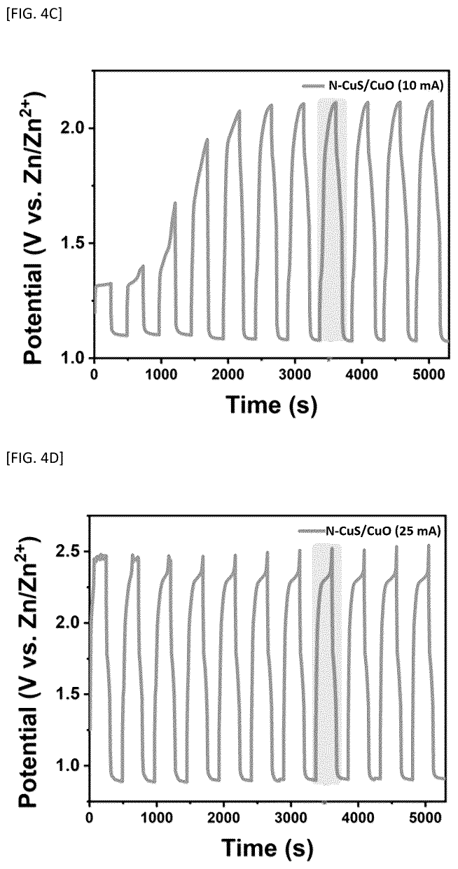

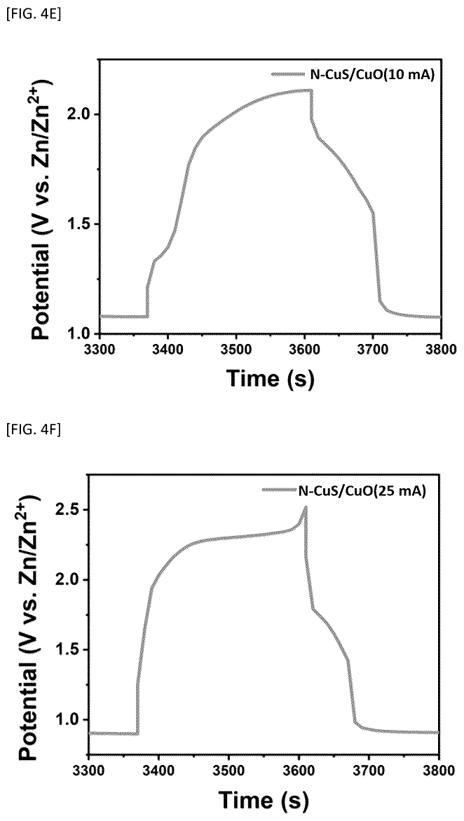

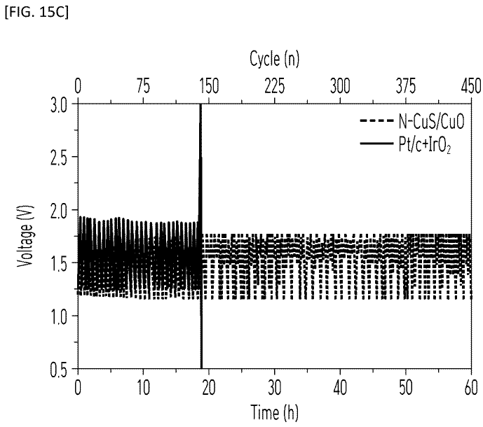

Furthermore, flow cell testing was made to evaluate ZAB characteristics, in which Zn metal, N—CuS/CuO air cathode, and 6 M KOH were employed as an anode, cathode, and electrolyte, respectively. Besides, constant oxygen flow was used to determine ZAB performance. ORR performance was measured using charging/discharging polarization curves measured by linear sweep voltammetry (LSV), as shown in FIG. 4A. Furthermore, the cell potentials were evaluated under various discharge current density conditions (1 mA, 5 mA, 10 mA, 25 mA) to validate the nitrogen plasma effect (FIG. 4B). Plasma treatment was performed at 2 min, 4 min, and 6 min intervals to optimize the nitrogen doping condition. FIG. 12A shows that the 4 min N₂ plasma cathode has the maximum discharge efficiency at all current densities. The reduction process is represented by a high-voltage plateau of 1.20 V at 1 mA, 1.16 V at 5 mA, 1.09 V at 10 mA, and 0.87 V at 25 mA for N—CuS/CuO with 4 min N₂ plasma. However, the pristine catalyst exhibited a voltage plateau responding to the reduction process of 1.17 V at 1 mA, 1.05 V at 5 mA, 0.93 V at 10 mA, and 0.75 V at 25 mA. The cell potential was observed to decrease as the current increases from 1 mA to 25 mA, but N—CuS/CuO showed to outperform pristine CuS/CuO. The cyclability of a ZAB was also evaluated by galvanostatic cycling with potential limitation (GCPL) at the current densities of 10 mA cm⁻² and 25 mA cm⁻² for 4 minutes each cycle (FIG. 4C to FIG. 4F). N—CuS/CuO showed a lower charging voltage and a higher discharging voltage than CuS/CuO. This signals that during reversible cell operation, the voltage applied to the cell does not need to be high in order to retain a high discharging characteristic. For comparison with Pt/C, the stacked cell configuration was measured by linear sweep voltammetry (LSV) and showed higher current density output (FIG. 13A) and power density (FIG. 13B). Additionally, the total performance was assessed in a stack cell configuration with a thin zinc foil anode. The measured specific capacity of the cell was 789.3 mA˜h˜g⁻¹, which corresponds to 85% of the predicted specific capacity (820 mA˜h˜g⁻¹), and it led to a gravimetric energy density of 666.75 Wh˜kg⁻¹. It is worth noting that these ZAB properties are comparable to Pt/C and the current state-of-the-art catalyst. Additionally, the cycling stability test results (FIG. 15A to 15C) reveal that the ZAB with N—CuS/CuO cathode enables about 3-fold longer cyclability than the ZAB with Pt/C cathode.

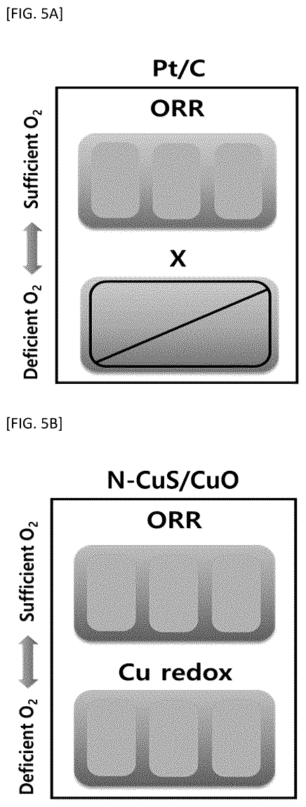

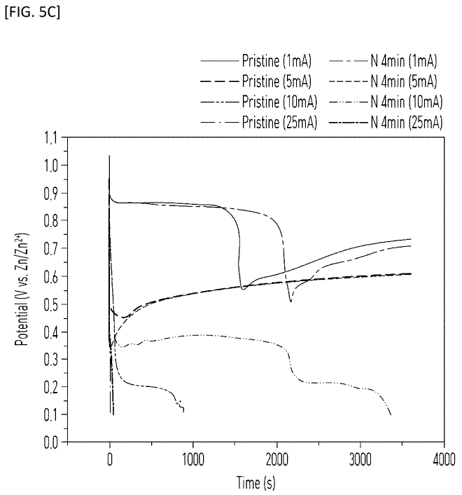

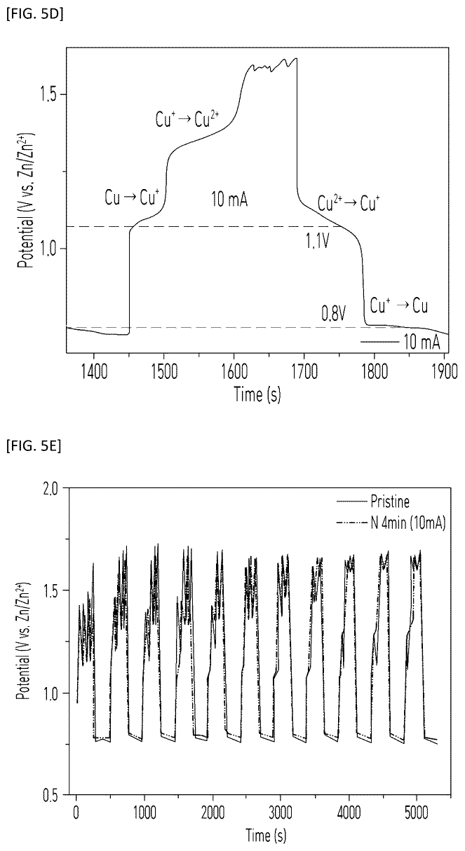

Furthermore, assembling N—CuS/CuO cathode and Zn metal anode in the so-called Zn—Cu full cell demonstrates that it can function in oxygen-free anaerobic conditions. Pt/C, which is the top performing ORR catalyst, requires oxygen for cell operation. CuS/CuO has the benefit of being able to function utilizing Cu redox reactions even in an oxygen-free environment, as shown in FIG. 5A and FIG. 5B. To check cell function, we performed chronopotentiometry analysis at various discharge rates (FIG. 5C). CuS/CuO remained stable for a long period of time. This finding proves that the Zn—Cu cell system can work well even in an oxygen-free environment. The plot of charging and discharging over time was magnified for a thorough investigation of Cu redox reactions (FIG. 5D). For both charging and discharging, two plateaus were observed at 1.1 V and 0.8 V. The plateau voltages were observed to match with the voltages at which Cu²⁺for CuO are reduced to Cu⁺ for Cu₂O and then followed to Cu (pristine Cu). This cascade battery-mode operation involving in copper oxide transitions (CuO→Cu₂O→Cu) during discharge resulted in the generation of O₂ molecules, thereby allowing efficient ORR under anaerobic conditions. As result, CuS/CuO cathode electrode was found to allow stable operation even under oxygen-deficient circumstances when integrated as a flow cell. Consequently, CuS/CuO provides a way to overcome the limitations of Pt/C electrode giving extremely restricted or no performance when the oxygen supply is shut off. Furthermore, after each stage of Cu reduction, the electrodes were taken from the cell and then characterized through XPS analysis. The XPS spectra reveals that the copper is reduced at each stage, thereby providing the evidence that cascade redox oxide transitions operates occur in an oxygen-free environment. Additionally, to confirm the performance change with repeating charging and discharging, the GCPL analyses (FIG. 5E and FIG. 5F) were performed. N—CuS/CuO showed distinct potentials during charging and discharge. When the current density was 25 mA, the results was more strongly verified than when the current density was 10 mA.

The ORR/OER mechanisms in both anaerobic and aerobic conditions have been also explored using DFT calculations. FIG. 6E depicts the free energies for OER/ORR versus reaction coordinates. Moreover, under oxygen-free conditions, FIG. 6F shows that two discharge reactions are caused by copper oxide transitions (CuO→Cu₂O→Cu) by

2CuO(s)+2H⁺+2e⁻→Cu₂O+H₂O(I)(E₀=0.67 vs. SHE) (1)

Cu₂O(s)+2H⁺+2e⁻→2Cu+H₂O(I)(E₀=0.47 vs. SHE) (2)

The Nernst Equation (ΔG=−nFΔE) was used to determine the standard potential for reactions after determining the Gibbs free energy of two reactions. The DFT calculations revealed E₀=0.72 V for CuO→Cu₂O and E₀=0.52 V for Cu₂O→Cu using the revised Perdew-Burke-Ernzerhoff functional plus effective Coulomb interaction (RPBE+U) with U_{eff}=4 eV. These values are similar to 0.67 eV and 0.47 eV from experiments. We determined the best DFT exchange-correlation functional and parameter for precise calculations of bulk CuO, Cu₂O, and Cu. Based on the functional and parameters obtained from the bulk calculation, surface reduction calculation of CuO and Cu₂O are conducted. Consequently, we find that the DFT results are consistent with the cascade battery-mode operation mechanism. As result, N—CuS/CuO electrode was found to allow stable operation even under oxygen-deficient conditions.

### 3. Conclusion

In the present invention, we report a bifunctional serrated leaf-like nitrogen-doped copper sulphide/oxide (N—CuS/CuO) cathode structure allowing efficient OER/ORR activity via cascade aerobic and anaerobic battery modes. N—CuS/CuO possesses electron-conductive N p-S 3p mix orbitals, oxygen-transporting open pore channels, and a about 75-fold higher catalytic surface than bulk copper oxides. Under aerobic conditions, the ZABs with N—CuS/CuO cathode enables high energy density (667 Wh/kg) and excellent cycle stability. Moreover, in anaerobic circumstances, N—CuS/CuO cathode retains metallic and oxidized coppers serving as cascade redox sites. Oxygen molecules created via cascade battery-mode copper oxide transitions (CuO→Cu₂O→Cu) with two plateaus (1.1 V and 0.8 V) allow efficient ORR under anaerobic conditions, whereas reverse transitions occur via oxidation by oxygen generated in OER, overcoming the limitations of present ZABs with Pt/C resulting in a sudden power loss when the air supply is cut off.

In the present invention, we synthesized a bifunctional serrated leaf-like nitrogen-doped copper/sulphide oxide catalyst (N—CuS/CuO) that render efficient ORR/OER activity for ZABs. CuS/CuO has high electrical conductivity for fast electron transfer as well as open porous architecture allowing continuous oxygen flow from air. A single-step anodizing technique has been implemented to result in the drastically increased surface area by lacerating the metal surface and forming copper sulphur oxide nanoflakes that facilitate quick oxygen transport. Moreover, nitrogen plasma dopants are subsequently incorporated into copper sulphur oxide nanoflake surfaces to boost catalytic activity. Nitrogen dopant atoms are shown to boost the affinity of the redox-active sites for oxygen. Furthermore, N p-states mix with S 3p states to result in high conductivity. We demonstrate that the synergistic impact of N and S sites leads to a significant increase in catalytic activity. Additionally, it is exhibited that N—CuS/CuO cathode preserves metallic and oxidized coppers as redox-active sites in the absence of air, thereby paving the way for sustained operation in severe circumstances such as deep underwater or high altitude.

To summarize, we synthesized N—CuS/CuO catalyst and proved that it functions as a bifunctional OER/ORR catalyst for ZABs. Anodization and microwave nitrogen plasma treatment were used to modify the surface of the material. Anodization was employed to create a defect-rich surface as well as rapid oxygen transport routes. Electric energy-driven chemical processes modify the electrode surface while permitting element deposition dependent on an electrolyte. The electrolyte employed in this invention contributed to the formation of copper sulphur oxide on the electrode surface during electrolysis. The copper sulphur oxide catalyst was then used to treat the N₂ plasma chemicals. As a result, the surface area, oxygen affinity, and conductivity increased. Indeed, N atoms doped into CuS/CuO were shown to behave as active sites, increasing catalytic processes by 75 times. Furthermore, the produced N—CuS/CuO cathode material was found to function via the two cathodic reaction modes. The battery functions in a Zn-air battery mode in an aerobic atmosphere, converting oxygen from the surrounding air to hydroxides. ZAB cells constructed with N—CuS/CuO cathode have a greater discharge potential and a lower charging potential. Furthermore, the high ORR discharge voltages resulted in a high energy density (667 Wh/kg). Under anaerobic conditions, on the other hand, copper oxides (CuO→Cu₂O→Cu) with two plateaus (1.1 V and 0.8 V) during discharge were reduced to enable efficient ORR, while reverse transitions occurred via oxidation by oxygen generated via OER, providing a route to overcome the limitations of Pt/C electrodes not working at anaerobic conditions. Consequently, this invention suggests that a non-precious metal-based catalyst might be used as a bifunctional catalyst for ORR/OER to achieve high energy density and cycle stability in ZIBs via cascading aerobic and anaerobic battery modes, which are hard to achieve with precious catalysts such as Pt/C.

The above description of the example embodiments is provided for the purpose of illustration, and it would be understood by those skilled in the art that various changes and modifications may be made without changing technical conception and essential features of the example embodiments. Thus, it is clear that the above-described example embodiments are illustrative in all aspects and do not limit the present disclosure. For example, each component described to be distributed can be implemented in a combined manner.

The scope of the inventive concept is defined by the following claims and their equivalents rather than by the detailed description of the example embodiments. It shall be understood that all modifications and embodiments conceived from the meaning and scope of the claims and their equivalents are included in the scope of the inventive concept.

1. An electrode, comprising a catalyst,
wherein the catalyst, comprising:
a substrate comprising a copper metal and a copper oxide formed on the copper metal,
a copper sulfide formed on the substrate, and
a nitrogen dopant existing in each of the substrate and the copper sulfide.

2. The electrode of claim 1,
wherein the substrate contains pores.

3. The electrode of claim 1,
wherein the copper oxide includes CuO and/or CuO₂.

4. The electrode of claim 1,
wherein the copper sulfide includes CuS and/or CuS₂.

5. The electrode of claim 1,
wherein the copper sulfide includes the copper sulfide in the form of a flake.

6. The electrode of claim 5,
wherein the flake has a diameter of 1 μm to 5 μm and a thickness of 30 nm to 70 nm.

7. The electrode of claim 1,
wherein the catalyst exhibits bifunctional catalytic activity for oxygen evolution reaction (OER) and oxygen reduction reaction (ORR).

8. A metal-air battery, comprising:
the electrode according to claim 1; an anode comprising a metal; and an electrolyte.

9. The metal-air battery of claim 8,
wherein the metal-air battery is a zinc-air battery, an aluminum-air battery, a magnesium-air battery, or a lithium-air battery.

10. The metal-air battery of claim 8,
wherein the metal-air battery operates under aerobic conditions.

11. The metal-air battery of claim 10,
Wherein an energy density of the metal air battery is at least 660 Wh/kg.

12. The metal-air battery of claim 8,
wherein the metal-air battery operates under anaerobic conditions.

13. The metal-air battery of claim 8,
wherein the metal-air battery has two voltage plateaus.

14. A method of preparing a catalyst, comprising:
anodizing a substrate comprising a copper metal and a copper oxide formed on the copper metal using an electrolyte containing sulfur to form a copper sulfide on the substrate, and to obtain a copper sulfide/oxide; and
treating with a nitrogen plasma the copper sulfide/oxide to obtain a catalyst.

15. The method of claim 14,
wherein the electrolyte containing sulfur includes at least one selected from Na₂S and K₂S.

16. The method of claim 14,
wherein the anodizing is performed for 1 minute to 30 minutes.

17. The method of claim 14,
wherein the treating with a nitrogen plasma is performed for 1 minute to 10 minutes.
